(19) United States
(12) Patent Application Publication
(10) Pub. No.: US 2003/0114176 A1
(43) Pub. Date: Jun. 19, 2003

(54) Barcode identification of wireless terminals

(76) Inventor: John Quentin Phillipps, Ealing London (GB)

Correspondence Address: ALUN L. PALMER, PATENT AGENT, 4300 PINEY CHURCH ROAD, WALDORF, MD, 20602, US

(21) Appl. No.: 10/343,010

(22) PCT Filed: Jun. 27, 2001
(86) PCT No.: PCT/GB01/02867

(30) Foreign Application Priority Data
Jul. 25, 2000 (GB) 0018237.8

(51) Int. Cl. H04B 7/00

(52) U.S. Cl. 455/500

(57) ABSTRACT

When a wireless connection is to be formed between a PDA 1, for example, and a printer 11, for example, the user of the PDA 1 causes it to read a code 13, e.g., a barcode, from the printer 11 so that the PDA 1 can identify the printer 11 in a list 20 of discovered neighbouring devices and, consequently, send appropriate connection set up signals to the printer 11 rather than inadvertently to some other device.

### FIELD OF THE INVENTION

The present invention relates to wireless communication.

### BACKGROUND TO THE INVENTION

Devices implementing the Bluetooth standard have recently begun to appear. Bluetooth provides a common standard by which devices, such as PDAs (Personal Digital Assistants), mobile phones, printers, etc., can communicate with each other wirelessly. Bluetooth uses radio signals in the 2.4 GHz Industrial-Scientific-Medical band.

Bluetooth has a weakness in that problems arise in discovering an intended recipient for a communication in a crowded environment, such as a conference where many people are exchanging electronic business cards or on a commuter train where many people have Bluetooth connections between mobile phone or music playing devices and ear phones. A Bluetooth device must perform a time-consuming discovery operation which will actually locate every Bluetooth device in the local environment. The user is then provided with a bewildering list of devices from which he must select the correct device.

It is an aim of the present invention to solve the afore-mentioned problem of Bluetooth and similar systems.

### SUMMARY OF THE INVENTION

According to the present invention, there is provided a method of establishing a wireless connection between two devices, the method comprising storing in a first device a list of ids of connectable devices, using the first device to read an external code from a second device, selecting an id from said list in dependence on said read code and sending connection establishing signals to the second device in response to said selection.

According to the present invention, there is also provided a device including code reading means, wireless communication means and processing means programmed to cause the device to perform a method according to the present invention.

According to the present invention, there is further provided a device including wireless communication means, processing means for controlling the wireless communication means for wireless networking with other devices, a memory storing a device id and an external code corresponding to said device id.

The code is conveniently an optical barcode. It should be appreciated that the term “code” used herein does not exclude markings that are intelligible to humans. For instance, a human can easily learn to read a written representation of Baudot code, which was of course designed for machine-to-machine communication.

The code need not be permanently readable. For instance, the code may be a pattern produced on an LCD which would disappear in the event of the device bearing it being switched off or becoming inoperative due to a failure.

Advantageously, the code includes a device type identifying part. This can be used for automatically configuring the first device.

### BRIEF DESCRIPTION OF THE DRAWINGS

FIG. 1 is a block diagram of a device according to the present invention;

FIG. 2 illustrates a piconet;

FIG. 3 shows the display of the device of FIG. 1 during connection to another device;

FIG. 4 is a flowchart illustrating the device of FIG. 1 operating according to the present invention; and

FIG. 5 is a flowchart illustrating the operation of a second device according to the present invention.

### DETAILED DESCRIPTION OF THE PREFERRED EMBODIMENT

Embodiments of the present invention will now be described, by way of example, with reference to the accompanying drawings.

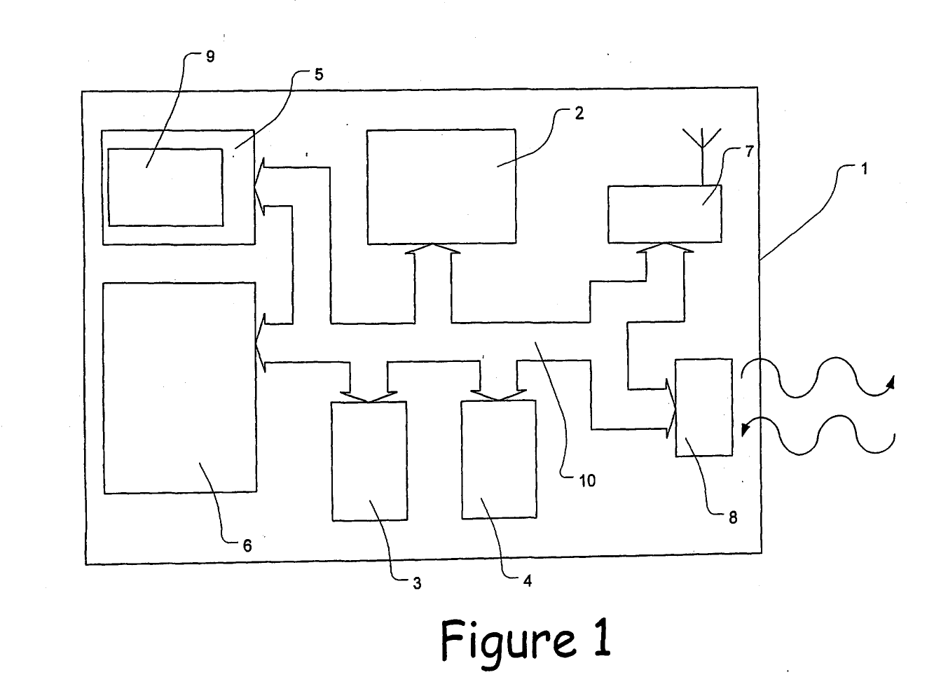

Referring to FIG. 1, an electronic device 1, which may be a PDA, a mobile phone, or other device, comprises a processor 2, RAM 3, ROM 4, display circuitry 5 including a display 9, user input circuitry 6, an rf subsystem 7 and a barcode reader subsystem 8 interconnected by a bus 10. The device 1 may have additional circuits and mechanical elements (not shown) which are required for its particular function, e.g. signal processing in the case of a mobile phone and a printing engine in the case of a printer.

The ROM 4 contains Bluetooth routines for controlling communication using the rf subsystem 7 which are accessible to programs being run by the processor 2 via an API.

The rf subsystem 7 comprises transceiver circuitry, including a local oscillator, and a controller for controlling the transceiver circuitry in response to commands from the processor 2. The transceiver is adapted for frequency hopping transmission and reception according to the Bluetooth specification.

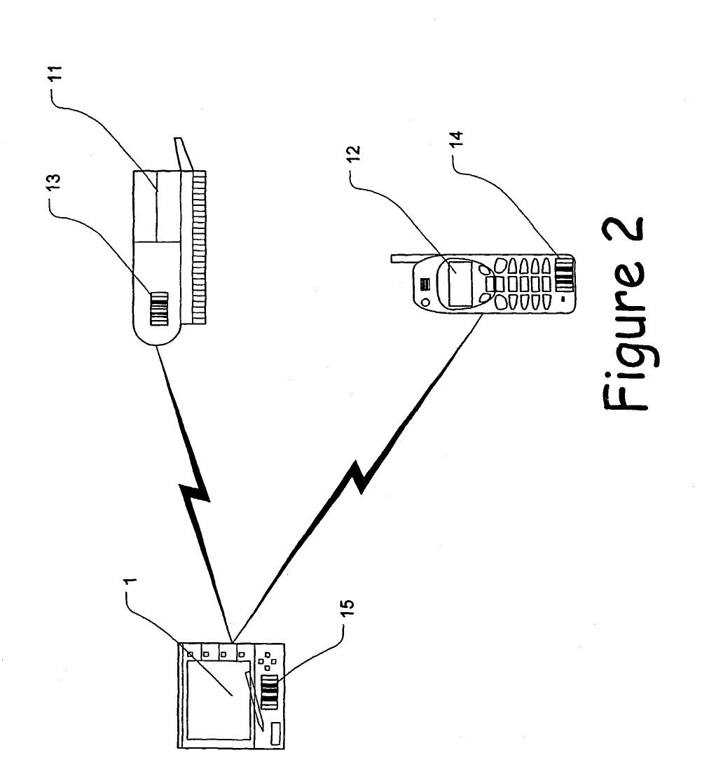

Referring to FIG. 2, the device 1 can connect with other Bluetooth enabled devices, in this case a printer 11 and a mobile phone 12 to form a “piconet”. The printer 11, the mobile phone 12 and the device 1 have respective barcodes 13, 14, 15 on their outer surface. The bar codes 13, 14, 15 represent the Bluetooth Device Addresses for the printer 11, the mobile phone 12 respectively and the device 1.

Bluetooth devices perform a discovery operation to locate other Bluetooth devices in their neighbourhood and add discovered devices to an internally stored list.

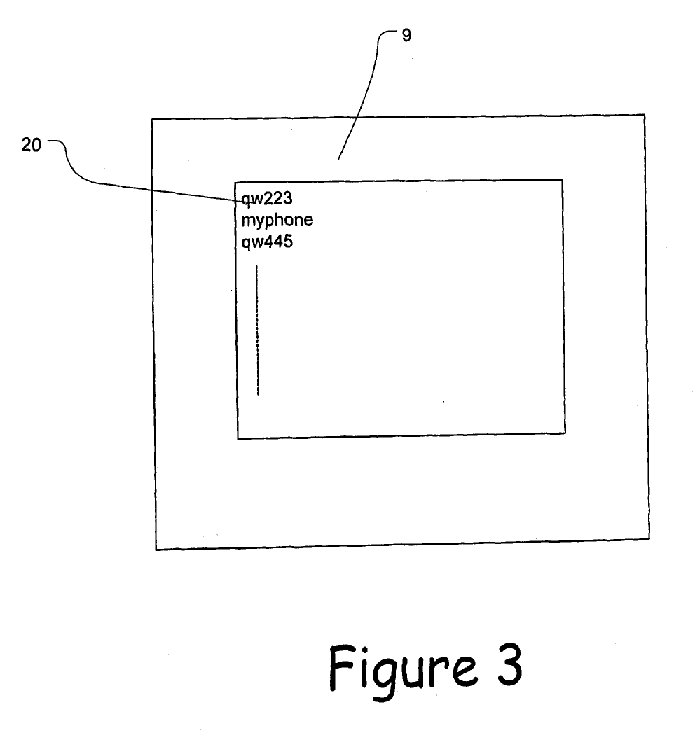

Referring to FIG. 3, when the user of the device 1, which is a PDA in this case, wishes to print using the printer 11, the user is presented by the PDA with a list 20 of the Bluetooth Device Addresses of discovered Bluetooth devices on the display 9. If the user knows the Bluetooth Device Addresses of the printer 11, the user can manually select the appropriate entry in the list 20 so that the device 1 can form a piconet with the printer 11.

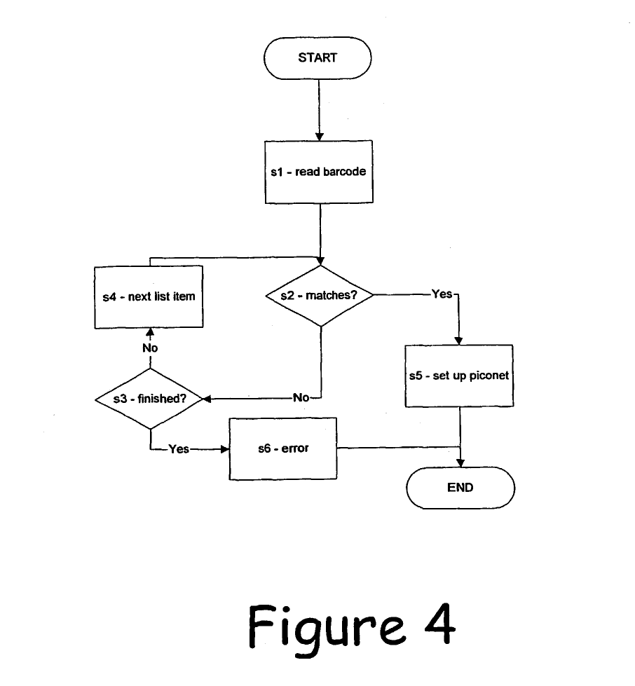

Referring to FIG. 4, if the user does not know the Bluetooth Device Address of the printer 11, the user can approach the printer 11 and using software in the ROM 4 activate the barcode reader subsystem 8 to read the barcode 13 from the printer 11 (step s1). The device's processor 2 then searches the members of the list 20 for a match (steps s2, s3 and s4) and, if one is found (step s2), sets up a piconet connection with the device identified by the match, i.e. the printer 11 (step s5) by sending connection establishing signals to the printer 11. If a match is not found in the list, an error is signalled to the user (step s6).

Barcodes have been given in the foregoing as an example of machine-readable indicia. It will be appreciated that other forms of optically readable codes or symbols and magnetic codes could be used.

It will be appreciated that the list 20 need not be displayed and that codes may be read from devices whenever a connection is required to be established.

In a second embodiment, the barcode is extended to include a device id code, comprising a type part and a model part. For instance, the barcode 13 on the printer 11 would comprise the printer's Bluetooth Device Address and a code identifying it as a printer of “Thingamyjig 2000” type. The code identifying the device type can then be used by the connecting device 1 to configure itself, e.g. selecting the appropriate driver for the printer being connected to. Another example, would be to start appropriate processing software. For example, a code identifying a device as a video camera would cause the device reading the code to start video display software in preparation for receiving video signals from the camera.

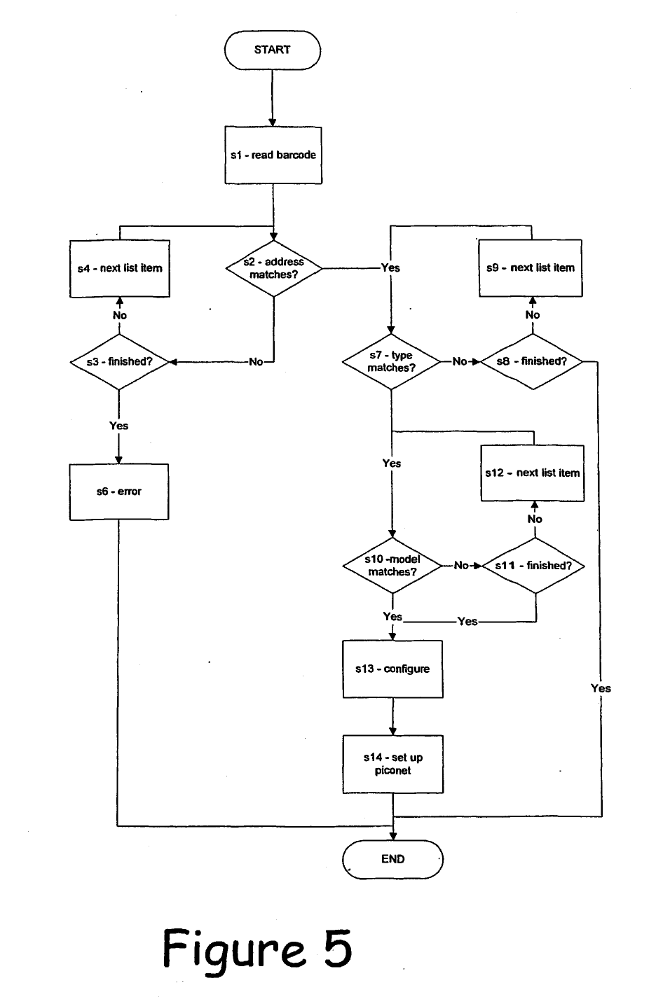

Referring to FIG. 5, the process of finding the Bluetooth Device Address from the barcode in the list 20 (steps s1 to s6) are the same as in the previous embodiment. However, if the Bluetooth Device Address is found in the list 20, the connecting device's processor 2 searches (steps s7, s8 and s9) an internally stored list of device type codes for a match with that from the barcode. If no match is found (step s8) the process is exited. However, if a match is found (step s7), the processor 2 searches (steps s10, s11 and s12) a list of known models of devices of the identified type. If a match is found (step s10) or no match is found (step s11), the process moves onto a configuration step (step s13). In the configuration step, the processor 2 identifies any device type and, if relevant, model specific actions to be performed, e.g. driver selection or application program execution, and performs these actions. Following the start of step s13, the processor 2 proceeds to set up the piconet connection (step s14).

It will be appreciated that many modifications may be made to the embodiments described above.

1. A method of establishing a wireless connection between two devices, the method comprising:—
storing in a first device a list of ids of connectable devices;
using the first device to read an external code from a second device;
selecting an id from said list in dependence on said read code; and
sending connection establishing signals to the second device in response to said selection.

2. A method according to claim 1, wherein said code is an optical barcode.

3. A method according to claim 1 or 2, wherein said code includes a device type identifying part.

4. A method according to claim 3, including automatically configuring the first device in dependence on said device type identifying part.

5. A device including code reading means, wireless communication means, a memory for storing a list of ids of connectable devices and processing means programmed to operate the code reading means to obtain a code, select an id from a list of connectable device ids in said memory in dependence on said read code and operate the wireless communication means to send connection establishing signals to another device in response to said selection.

6. A device according to claim 5, wherein the code reading means comprises barcode reading means.

7. A device including wireless communication means, processing means for controlling the wireless communication means for wireless networking with other devices, a memory storing a device id and an external code corresponding to said device id.

8. A device according to claim 7, wherein the externally accessible code is an optically readable barcode.

9. A device according to claim 7 or 8, said code includes a device type identifying part.
